(19) United States
(12) Patent Application Publication
(10) Pub. No.: US 2010/0032605 A1
(43) Pub. Date: Feb. 11, 2010

(54) Closure apparatus for a pressure container, which can be filled with compressed gas, of a cold gas generator

(76) Inventors: Martin Haege, Boennigheim (DE); Helmut Grantz, Sindelfingen (DE); Gunnar Helms, Renningen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/311,615

(22) PCT Filed: Oct. 4, 2007
(86) PCT No.: PCT/EP2007/008616

§ 371 Date: Apr. 6, 2009

(30) Foreign Application Priority Data
Oct. 4, 2006 (DE) 102006047272.1
Jan. 17, 2007 (DE) 102007003320.8

(51) Int. Cl. F16K 1/00

(52) U.S. Cl. 251/324

(57) ABSTRACT

The invention relates to a closure apparatus for a pressure container (14), which can be filled with compressed gas, of a cold gas generator (11), wherein the pressure container (14) comprises a closed base at one end and a container opening (16) at the other end, on which container opening (16) the closure apparatus (12) can be arranged for forming a cold gas generator (11), having a valve body (48, 71) which, in a rest position, closes an ejection opening (18) which communicates with the surroundings, and which valve body (48, 71) can be transferred into a working position by way of a drive apparatus (31) for opening the ejection opening (18), wherein a device (33) which reduces the closing force to be applied and actuates the at least one valve body (48, 71) between a rest position and a working position is provided between at least one valve seat (51) of the ejection opening (18) and the drive apparatus (31).

The invention relates to a closure apparatus for a pressure container, which can be filled with compressed gas, of a cold gas generator as claimed in the pre-characterizing part of claim 1.

U.S. Pat. No. 6,068,288 discloses a closure apparatus for a pressure container, which can be filled with compressed gas, of a cold gas generator. Cold gas (generators of this type are used for vehicle air bag systems. The closure apparatus comprises a valve body which, in a rest position, closes a container opening communicating with the environment. An electromagnetic drive apparatus, by way of which the valve body can be transferred into a working position, is provided for outflow of the compressed gas. The closure body is embodied as a slide. A movement of displacement can release different flow paths to allow outflow of the compressed gas. Furthermore, the movement of displacement of the slide also causes the closure apparatus to be reclosed. This apparatus has the drawback that high forces are required for activating the slide. In addition, these elevated forces impede the activation of a slide of this type, above all the closing movement of the closure device. This is often associated with incomplete tightness, so that a leakage flow is provided and the cold gas generator can be used only to a limited extent or no longer at all for further applications.

The invention is therefore based on the object of providing a closure apparatus for a pressure container, which can be filled with compressed gas, of a cold gas generator and allows metered emission of the compressed gas, which is under high pressure, and secure closing after the emission of the compressed gas.

According to the invention, this object is achieved by the features of the main claim. Further advantageous configurations and developments are disclosed in further claims.

According to the invention, the closure apparatus has, between the valve seat of an ejection opening and the drive apparatus for actuating at least one valve body, a device which is to be applied to the valve body, which reduces the closing force and activates the valve body between a working position and a rest position. As a result of the reduction in closing force, a metered and exactly controllable emission of the compressed gas, which is under high pressure and is to be emitted, from the pressure container is facilitated. At the same time, the force for opening the closure apparatus can also be reduced. In a pressure container of this type, the compressed gas will be present at an operating pressure of from, for example, 600 to 1,000 bar. The opening and closing movement of the closure apparatus must take place within a few milliseconds and work against these high operating pressures. Both abrupt opening of the closure device and rapid blocking of the container opening can be facilitated by a device reducing the closing force to be applied to the valve body. The electrical activation of the closure apparatus allows the amount of compressed gas required for an air bag to be adapted as a function of the severity of an accident, such as for example the impact speed. Furthermore, the filling speed and also refilling of a pressure bag can be facilitated in the event of a secondary impact.

According to a preferred embodiment of the invention, provision is made for the device to have a pressure element having at an end pointing toward the valve body at least one pressure surface, by which at least one valve body can be transferred for abutment against an opening of a valve seat. This allows the generation, via the pressure surface which is embodied in particular in a conical manner, of leverage forces which reduce the closing force which is actually required. At the same time, a low release force is also facilitated, thus allowing simple activation via an electric drive.

According to a preferred embodiment, there are provided on a valve insert a plurality of radially oriented openings with each of which a valve body is associated. The preferably conical pressure surface of the pressure element acts preferably jointly on the valve bodies. The valve bodies can for example be embodied as sealing balls or sealing segments which are arranged relative to one another in the circumferential direction by a cage. As a result of the conical surface on the pressure element, all valve bodies can preferably be acted on uniformly and simultaneously, so that a rapid closing movement is also facilitated. Alternatively, a successive closing movement of individual valve bodies can also be provided.

Furthermore, provision is preferably made for the pressure element to be able to be activated by the drive apparatus so as to be displaceable to at least one valve body and the pressure surface on the pressure element to be embodied at an acute angle to the direction of displacement. As a result, a very high contact force can be brought about in order to position the valve bodies for opening on the valve insert in the direction of radial movement and to close the respective opening. The stroke distance and the inclination of the conical surface can be adapted to the shape of the valve bodies and the required opening cross section. The pressure surface can also have a curved or hyperbolic course.

The pressure element and the valve insert form preferably a receiving space for the valve bodies, which is delimited by a radially oriented abutment surface. This abutment surface directly adjoins a radial opening on the valve insert. As a result, the valve bodies, in particular the sealing balls, remain in this receiving space. At the same time, this abutment surface acts as a counter bearing during the closing movement of the pressure element in order to move the valve bodies toward the opening in the valve insert via the slant.

According to this first advantageous embodiment, the pressure element comprises a cup-shaped portion which surrounds the at least one valve body. In this case, the cup-shaped portion receives at an internal free end the pressure surface, in particular a conical surface, and through-openings are provided between the base and the pressure surface on the cup-shaped portion. Thus, there can take place not only an outflow between the valve bodies, but rather an additional outflow of the compressed gas via the through-opening, thus (facilitating a rapid supply of the compressed gas in a pressure bag or air bag.

The pressure element has furthermore in the cup-shaped portion a guide acting on the outer circumference of the valve insert. As a result, the pressure element is guided in direct proximity to the valve bodies, thus facilitating exact guidance of the conical surfaces for positioning the valve bodies relative to the openings in the valve insert.

Preferably, a force storage element, in particular a compression spring which exerts a force on the pressure element in the closing direction of the valve bodies, is provided between the drive apparatus and the pressure element. As a result, it is possible, owing to the compression spring, for the closure apparatus to be transferred into and held in a rest position in a currentless state. This currentless rest position is required as a safety measure, so that there is no accidental outflow of the compressed gas in the event of failure of a control current. As a result of the device according to the invention for reducing the closing force, a compression spring having reduced compressive force can be provided, thus facilitating a reduction in overall space.

The force storage element is preferably provided in a chamber in the housing of the drive apparatus, which is embodied so as to be open toward the valve body and has lateral through-openings. As a result, a compact design can be attained in that the housing is fixed to the connecting edge of a cover of the pressure container and a flow path for the compressed gas from the pressure container to the air bag is released to allow rapid filling.

According to a preferred embodiment, the valve insert Q is fastened in an ejection opening in the cover for the pressure container. This cover can be a part of the closure apparatus or, already as a component, be securely pressed onto or connected to the pressure container. The valve insert is arranged in a central ejection opening in the cover, preferably so as to be releasable by a screw thread.

The drive apparatus has preferably a fastening portion which acts on a connecting edge of the cover, so that the drive apparatus can be mounted to the pressure container. Thus, the pressure container can also be provided separately to the closure apparatus and allows simple mounting and subsequent filling.

Furthermore, an excess pressure limiting valve, which can be inserted in a hole connecting the ejection opening to the environment, is preferably provided in the cover. As a result, a maximum high pressure for the container interior can be set.

Furthermore, provision is preferably made for the cover to have on the connecting edge a further fastening portion on which the bag or air bag, which can be filled with compressed gas, is arranged. This allows simple mounting. This fastening portion can be standardized, so that various embodiments of compressed gas bags can be fastened thereto.

A second preferred embodiment of the invention provides for a device which reduces the closing force to be applied to have a valve body which is embodied as a piston, abuts with an end face against a valve seat on the ejection opening and comprises a first pressure surface and for the valve body to be arranged opposite in a prechamber in which a restrictor valve can be used to set a prechamber pressure which is reduced compared to the operating pressure of the compressed gas and acts on a second pressure surface of the valve body in the prechamber. As a result of this configuration, a reduction of the closing forces is attained owing to a pressure compensation of the at least two pressure surfaces. Facilitated closing can be attained as a result.

For adjusting the prechamber pressure according to the second embodiment, the restrictor valve is provided in a channel connecting the prechamber to the pressure container. This provides a simple design in order to build up in the prechamber a pressure which can preferably be adjusted by the restrictor valve.

Furthermore, provision is preferably made for the piston to be held by a holding sleeve which can be arranged on the drive apparatus and for the holding sleeve to comprise a guide portion. As a result, the pressure element can be guided in a tilt-free manner. The holding sleeve can be embodied as a separate component or be integrated in one piece with the cover.

In order to reduce the forces by a pressure compensation in the device, provision is furthermore made for the valve body to have, between the first valve seat and a further valve seat formed by the holding sleeve, a third pressure surface to which atmospheric pressure is applied. This third pressure surface is preferably annular in its embodiment. Furthermore, this facilitates a reduction in force, as the forces from the pressure of the prechamber and the annular cross section of the third pressure surface and also of the first pressure surface add up. If the cross sections and the pressure difference are selected in a suitable manner, the resulting force can even be equal to zero.

Advantageously, sealing elements are provided between the holding sleeve and the housing of the drive apparatus and preferably between the guide portion of the holding sleeve and the valve body. As a result, stable prechamber pressures are maintained. At an operating pressure of the compressed gas in the pressure container of for example 800 bar, a prechamber pressure of for example 400 bar is preferably set via the restrictor valve.

According to a further advantageous configuration of the invention, a force storage element, in particular a compression spring which exerts a force in the closing direction, is provided in the prechamber. As a result of the pressure compensation attained via the pressure surfaces, a force storage element having a low force can be used to apply the necessary sealing pressure or the required sealing force, so that the closure apparatus securely closes the pressure container in the currentless state. At the same time, simple activation is facilitated, preferably via an electromagnet which works against the spring force during opening of the closure apparatus.

According to a preferred third alternative embodiment of the invention, provision is made for an opening movement of the valve body for opening the ejection opening in the cover not to be activated directly by the drive apparatus, but rather to be able to be activated via the prechamber pressure prevailing in the prechamber. For this purpose, provision is preferably made for the prechamber pressure to be able to be varied by a control valve which opens and closes a through-opening between the prechamber and a transverse hole to which atmospheric pressure is applied. The valve body is provided in the prechamber so as to be able to move freely. Owing to the pressure compensation between the container internal pressure and the prechamber pressure and also the conditions of the pressure surfaces, the piston remains in a closed position when the control valve is closed. As soon as the control valve opens and the compressed gas flows outward from the prechamber, the resulting excess pressure of the compressed gas in the pressure container will lift the valve body from the valve seat, and the compressed gas can escape.

Preferably, provision is made for the control valve to be able to be activated by the drive apparatus. As a result, the valve body is activated directly via the drive apparatus, i.e. the valve body is indirectly activated in order to transfer the valve body into a working position and to open the ejection opening.

Preferably, a force storage element, which applies a force to the control valve in the closing direction, is in turn provided. This in turn provides the safety function that the compressed gas container is kept closed in the currentless state of the closure apparatus.

According to a further advantageous configuration of the third embodiment, provision is made for the control valve to have a valve seat in an intermediate flange which receives the drive apparatus and can be arranged on the cover. This provides a modular construction, individual components being provided so as to be able to be exchanged in a simple manner. At the same time, a seal can be provided at the individual interfaces, so that the prechambers are in turn pressure-resistant.

According to a further alternative embodiment of the invention, provision is made for, between a guide portion of the valve body, which at least partly surrounds the valve body of the control valve, and a valve body of the control valve, a forced activation to be provided in such a way that during an opening movement of the valve body from the control valve, the valve body is raised from the at least one valve seat of the ejection opening. This forced control in a direction of movement allows very high gas volumes to be controlled at high pressures without particularly high forces having to be applied for this purpose. At the same time, opening is ensured.

The embodiments having a prechamber all have the advantage that simple filling of the pressure containers is facilitated without what is known as a bell, such as is required in pyrotechnically opened hybrid or cold gas generators.

Furthermore, this alternative embodiment has the advantage that the drive apparatus for activating the control valve can be designed as an electromagnetic drive. Owing to the low forces and the low stroke distance, piezoceramic plate stack drives or piezoceramic bending plate drives can for example also be provided.

According to a further preferred configuration of the invention, provision is made for the activation of the drive apparatus and/or the pressure containers to be monitored by a pressure sensor. As a result, single or multiple brief opening and closing of the valve can be carried out. The outflowing volume can also be determined by the activatable valve strokes. The use of pressure sensors of this type allows a closed control circuit, thus providing information about the amount of gas which has flowed out. The pressure sensor also allows the operativeness and the filling amount of the gas generator to be constantly checked. This facilitates maintenance in particular.

The invention and also further advantageous embodiments and developments thereof will be described and commented on in greater detail hereinafter based on the examples illustrated in the drawings. According to the invention, the features which may be inferred from the description and the drawings can be applied individually per se or jointly in any desired combination. In the drawings:

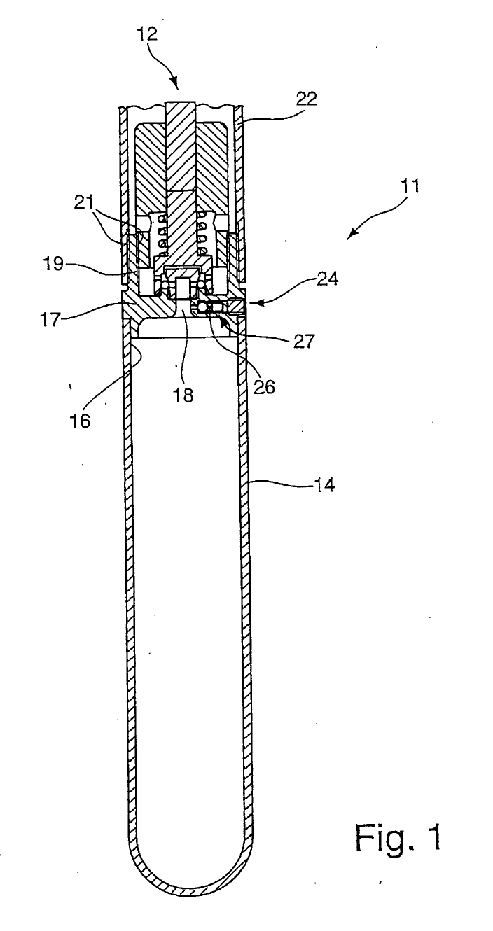

FIG. 1 is a schematic sectional view of a cold gas generator with a first embodiment according to the invention of a closure apparatus;

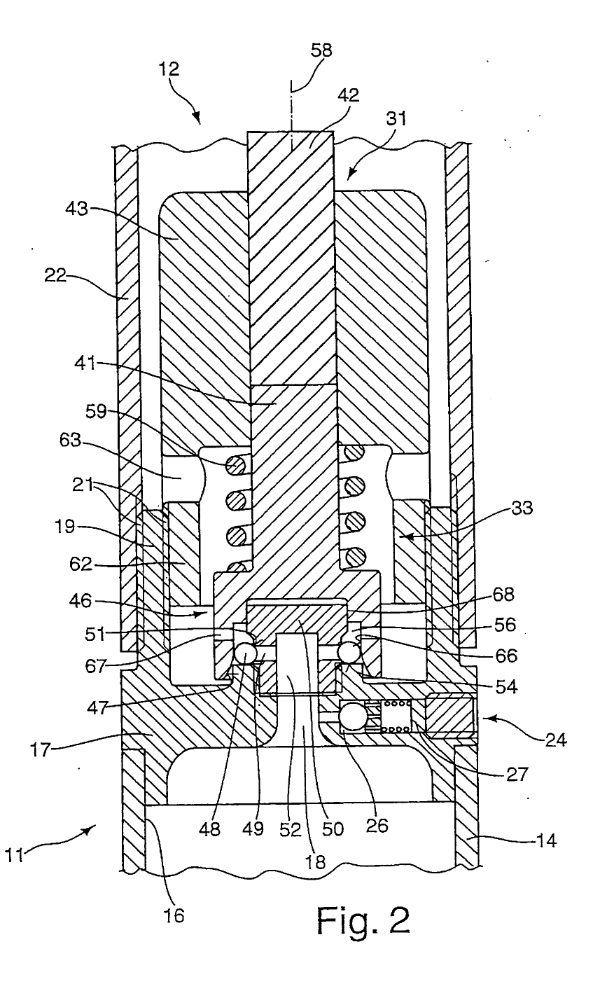

FIG. 2 is an enlarged schematic sectional view of the closure apparatus according to FIG. 1 in the closed state;

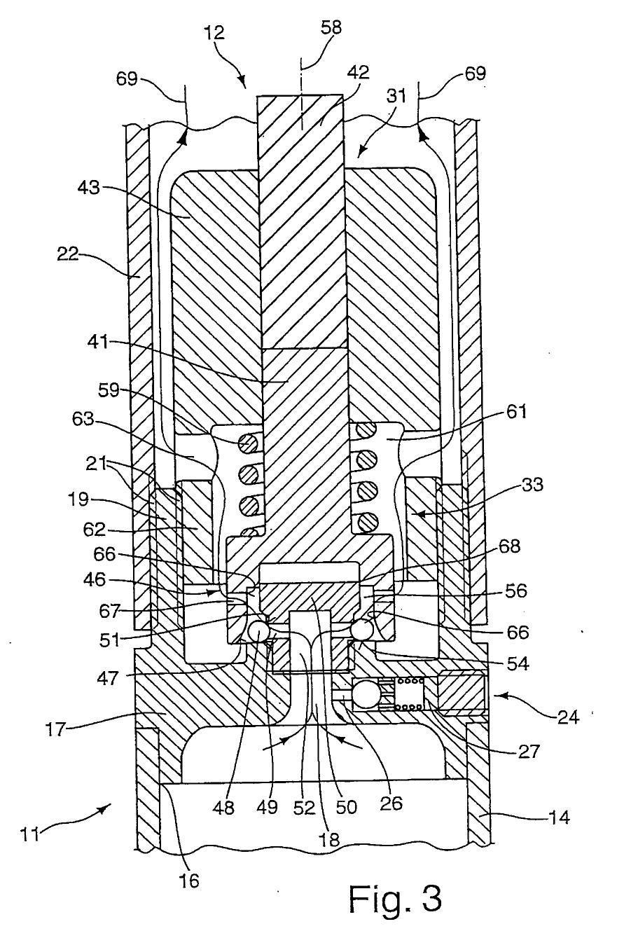

FIG. 3 is a schematically enlarged sectional view of the closure apparatus according to FIG. 1 in the opened state;

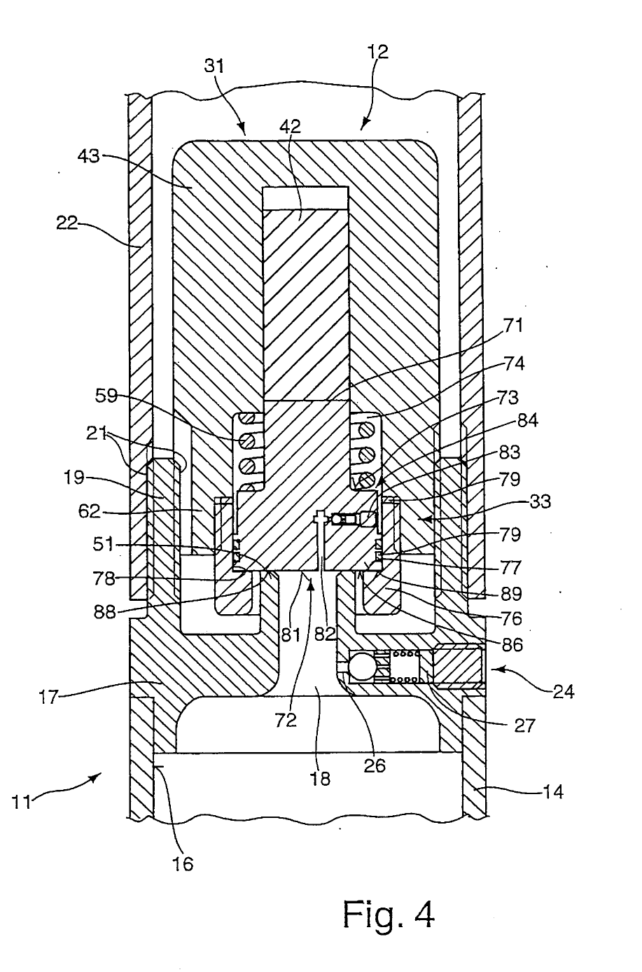

FIG. 4 is a schematic sectional view of an embodiment of a closure apparatus as an alternative to FIG. 1;

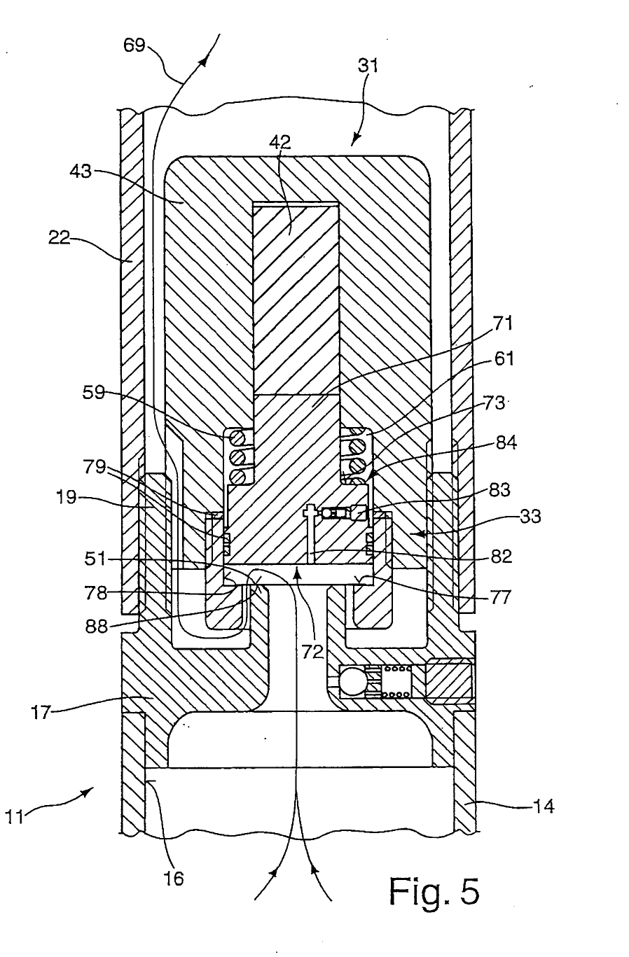

FIG. 5 is a schematic sectional view of the closure apparatus according to FIG. 4 in the opened state;

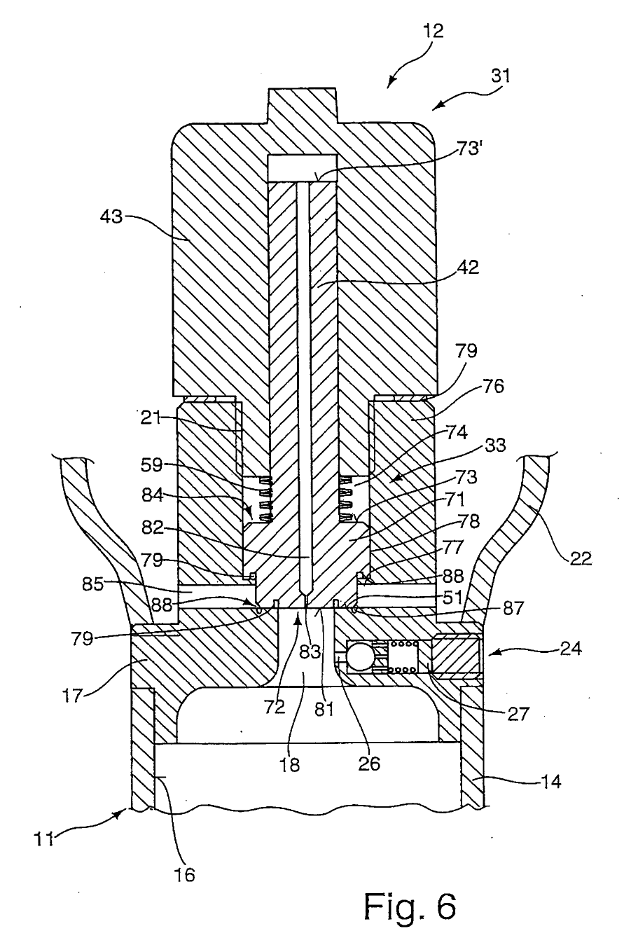

FIG. 6 is a schematic sectional view of a further embodiment of a closure apparatus;

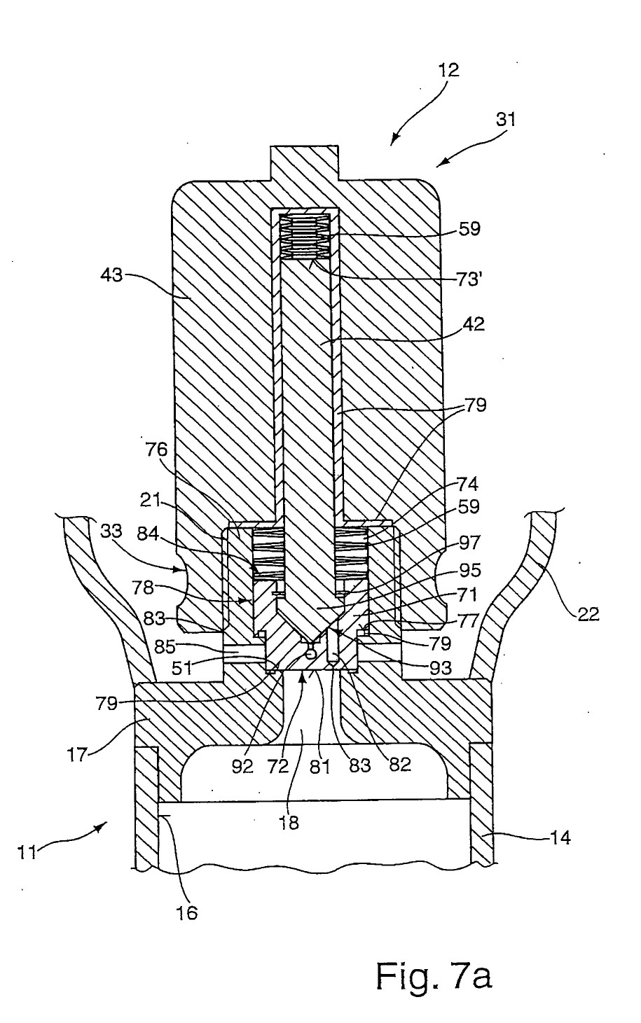

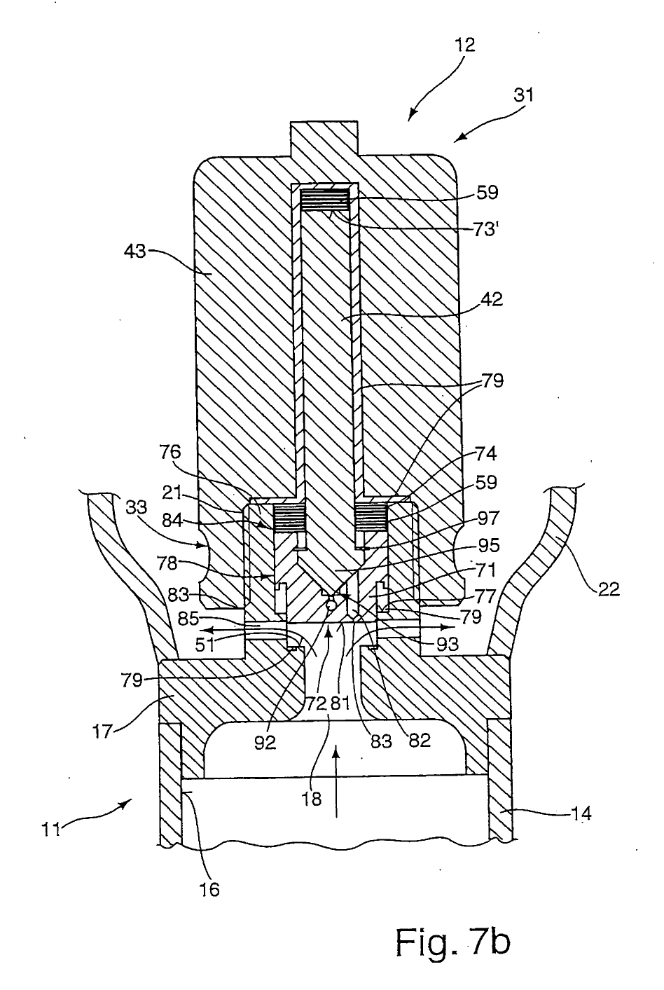

FIGS. 7a and b are a schematic sectional view of a further alternative embodiment of a closure apparatus according to FIG. 1;

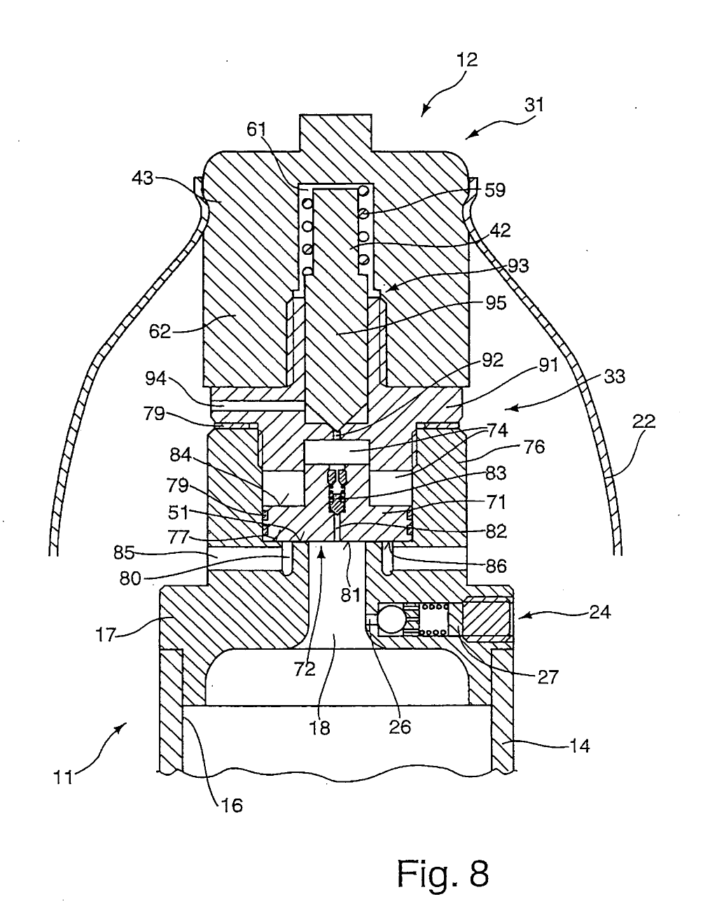

FIG. 8 is a schematic sectional view of an embodiment of a closure apparatus as an alternative to FIG. 1;

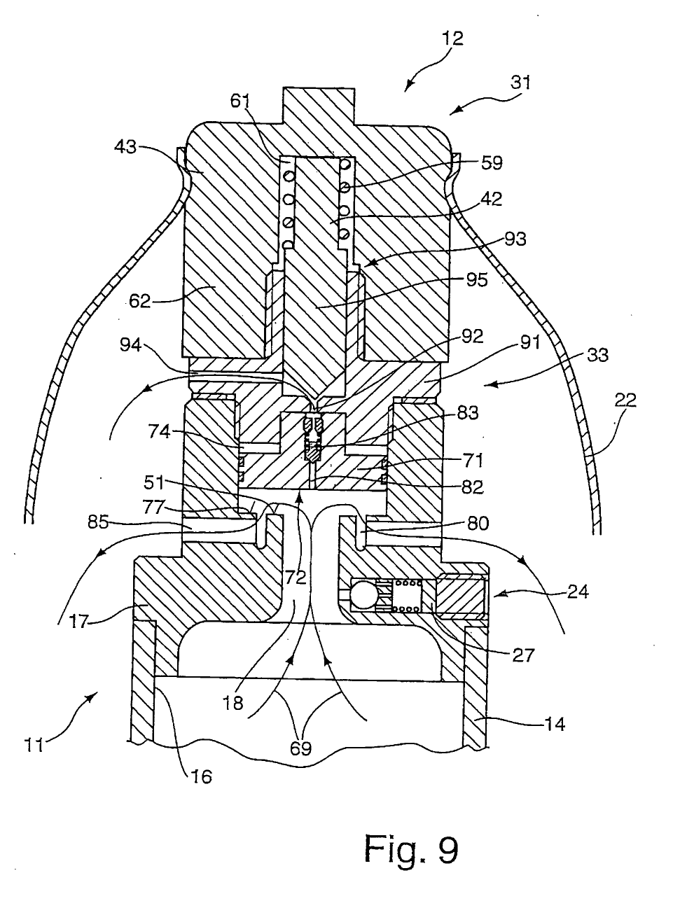

FIG. 9 is a schematic sectional view of the closure apparatus according to FIG. 8 in the opened state;

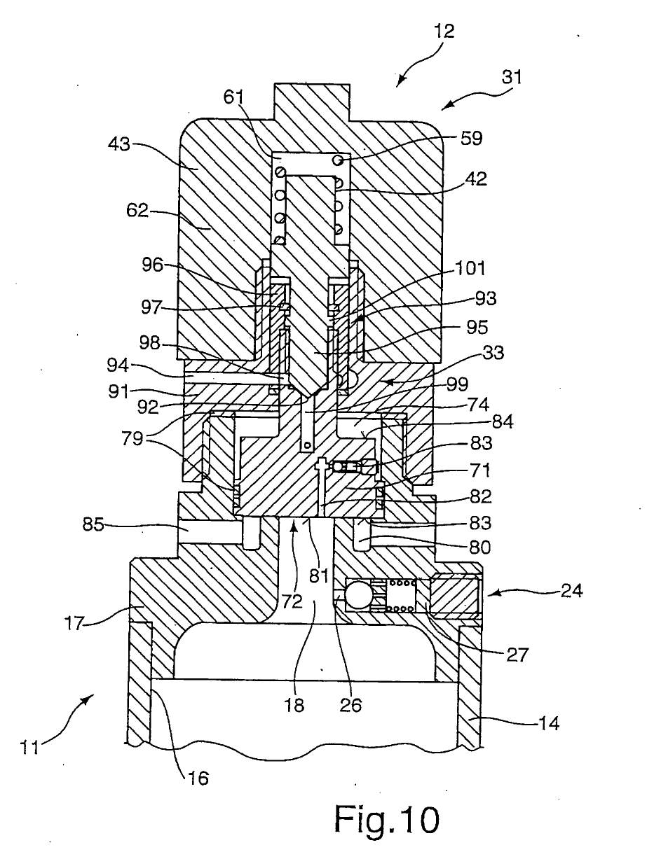

FIG. 10 is a schematic sectional view of an embodiment of a closure apparatus as an alternative to FIG. 1; and

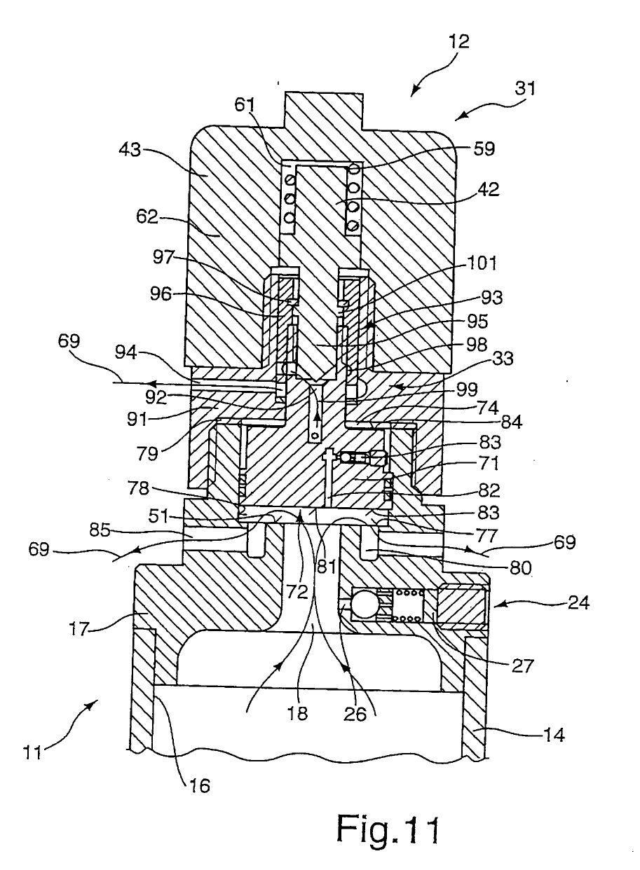

FIG. 11 is a schematic sectional view of the closure apparatus according to FIG. 10 in the opened state.

FIG. 1 is a schematic sectional view of a cold gas generator 11 with a first embodiment of a closure apparatus 12 which is provided on a pressure container 14. The pressure container 14 has at the upper end a container opening 16 which is closed by a cover 17. Alternatively, this cover 17 can also be embodied in one piece on the pressure container 14 or as a component of the closure apparatus 12. The cover 17 has, preferably centrally, an ejection opening 18 which can be activated by the closure apparatus 12. The cover 17 comprises a connecting edge 19 to which the closure apparatus 12 is releasably fastened. Furthermore, the connecting edge 19 can have a fastening portion 21, preferably a thread, to which a pressure bag 22 or an air bag attachment or a filling device is fastened in a medium-tight manner.

In this embodiment, provision is made for the closure apparatus 12 to be arranged outside the pressure container 14. Alternatively, the closure apparatus can also be provided in the pressure container 14.

An excess pressure limiting valve 24, which opens if the internal pressure rises above the admissible bursting pressure of the pressure container 14 and allows the compressed gas to be blown off, is provided in the cover 17. Preferably, provision is made for the excess pressure limiting valve 24 to comprise a pressure sensor 27 which is likewise arranged in a hole 26 connecting the container interior to an atmospheric pressure outside the pressure container 14. This pressure sensor 27 can be embodied as part of a pressure plate to detect the pressure applied. As a result, the filling amount of the compressed gas in the pressure container 14 can be detected.

FIG. 2 is an enlarged view of the closure apparatus 12 according to the invention. The closure apparatus 12 consists of a drive apparatus 31 which is preferably embodied as an electromagnetic drive. This drive apparatus 31 acts on a device 33 which reduces the closing force and is provided between a valve seat 51 of an ejection opening 18 and the drive apparatus 31.

The device 33, which reduces the closing force to be applied, comprises a pressure element 41 which is connected to an anchor 42 of the drive apparatus 31, which can be moved via an actuator 43 or electromagnet. The pressure element 41 has, at its end pointing toward the ejection opening 18, a cup-shaped portion 46, on the inside of which a preferably conical pressure surface 47 is provided. This conical surface 47 acts on at least one valve body 48 which is embodied for example as a pressure or sealing ball. This valve body 48 closes at least one opening 49 on a valve inside 50 which can be inserted into the ejection opening 18. The valve insert 50 has preferably a plurality of radially oriented openings 49 which are connected to an entry region 52 which merges with the ejection opening 18. Provided adjoining the opening 49 of the valve insert 50 is an abutment surface 54 which delimits a receiving space 56 formed between the valve insert 50 and the inner circumference of the cup-shaped portion 46 of the pressure element 41. The abutment surface 54 is embodied as an annular surface which can dip at least partly into the cup-shaped portion 46. The valve bodies 48 rest on the abutment surface 54.

The opening and closing movement of the pressure element 41 takes place along a longitudinal axis 58 which is preferably congruent with the axis of the ejection opening 18. The pressure element 41 can move upward against a force storage element 59 which is preferably embodied as a compression spring. The force storage element 59 is provided in a chamber 61 which is a part of a housing 62 of the drive apparatus 31 with which this housing is fastened to the connecting edge 19. Radially oriented openings 63 are in turn provided in the chamber 62 to allow the compressed gas to flow out.

The conical pressure surfaces 47 of the pressure element 41 are adjoined by a cylindrical wall surface 66 in which through-holes 67 are provided, so that the compressed gas entering the receiving space 56 can flow outward. A guide 68, which acts on an outer circumference of the valve insert 51, is provided on the base of the cup-shaped portion 46.

FIG. 2 shows the closure device 12 in a closed position. In this case, the drive apparatus 31 is currentless and the ejection opening 18 closed. The closing force is applied via the force storage element 59, wherein, owing to the device 33, the closing force of a force storage element 59, in particular a compression spring, is sufficient. Owing to the conical surface 47 or a control cam, the holding forces are greatly reduced. This arrangement according to the invention includes a gain factor corresponding to the tangent of the angle of the conical pressure surface 47 relative to the longitudinal axis 58.

FIG. 3 shows the closure apparatus according to FIG. 2 in a working position. The ejection opening 18 is opened, so that the compressed gas can pass from the pressure container 14 into the pressure bag 22 as indicated by the arrows 69. For opening the ejection opening 18, the actuator 43 of the drive apparatus 31 is supplied with current. The anchor 42 is drawn upward and works against the force storage element 59, so that the pressure element 41 is moved upward. In this case, the contact pressure acting on the valve bodies 48 is reduced by the conical surface 47 and, owing to the increasing angle or free space, the valve bodies release the openings 49 of the valve insert 50. The compressed gas can enter the receiving space 56 and from there pass via the transverse holes 67 to the chamber 61 and through the openings 63 into the pressure bag 22. For closing the closure apparatus, the drive apparatus 31 is switched to the currentless state. The stored force of the compression spring 59 leads the pressure element 41 toward the valve body 51. The valve bodies 51 are pressed toward the respective openings 49 via the conical pressure surfaces 47, so that the openings are closed.

FIG. 4 shows an alternative embodiment of the closure apparatus 12 according to FIGS. 1 to 3 in a closed position. FIG. 5 shows this alternative embodiment with an opened closure apparatus 12. This alternative embodiment has a closing force-reducing device 33 which differs from FIGS. 1 to 3. This device 33 will be described hereinafter in greater detail. Moreover, reference is made to the foregoing description.

The device 33 comprises a valve body 71 having an end face 72. Opposite, the valve body 71 comprises an annular surface 73 which points into a prechamber 74. The valve body 71 passes through the prechamber 74 with a ram or plunger and is connected to the anchor 42 of the drive apparatus 31. A force storage element 59, which acts on the annular surface 73 and in the chamber 61 of the housing 62, is in turn arranged in the prechamber 74. Furthermore, a holding sleeve 76, which holds the piston 71 in the prechamber 74, is provided on the housing 62. This holding sleeve 76 has a guide 78 which receives a circumferential wall portion of the piston 71 in a longitudinally displaceable manner in the prechamber 74. Preferably, the guide 78 can be provided by seals 79.

A valve seat 51, which is for example molded in one piece onto the cover 17, surrounds the ejection opening 18. The valve body 71 rests with the end face 72 against a first valve seat 51. The region of the end face 72 that covers the ejection opening 18 forms a first pressure surface 81. The internal pressure of the compressed gas acts on this pressure surface 81. A channel 82, which leads to the prechamber 74, is provided in the first pressure surface 81. A restrictor valve 83, which can be constructed in a similar manner to the excess pressure limiting valve 24, is provided in the channel 82. Compressed gas passes from the pressure container 14 into the prechamber 74 via the channel 82 as a function of the preset pressure of the restrictor valve 83. This compressed gas acts on the annular surface 73 which acts at least partly as the second pressure surface 84. An annular portion, to which atmospheric pressure is applied, is formed on the valve body 71 between the valve seat 51 and a valve seat 77 of the holding sleeve 76. This annular surface forms a third pressure surface 86.

The force-reducing device 33 is determined by the extent of the pressure difference between the operating pressure, the prechamber pressure of the compressed gas and the atmospheric pressure. The extent of the pressure difference thus forms the yardstick for the force with which the valve body 71 must be pressed against the valve seat 51. An example will illustrate this most clearly: The operating pressure of the compressed gas generates on the first pressure surface 81 a force which might raise the valve body 71. The pressure of the prechamber 74 presses against the first pressure surface 81 and also against the third pressure surface 86 with the force of the second pressure surface 84. As the third pressure surface 86 displays ambient pressure, the force is intensified as a result of the pressure of the prechamber 74 against the valve body 71 and the valve seats 51, 77.

The restrictor valve 83 can now be adjusted in such a way that the forces of the first to third pressure surfaces 81, 84, 86 are compensated for. In such a case, the force storage element 59 ensures the required sealing pressure and the actuator 43 has, during the opening of the ejection opening 18, to overcome merely the force of the force storage element 59. Preferably, the restrictor valve 83 is adjusted in such a way that the force acting on the valve body 71 on the prechamber side is slightly higher than the force which the gas pressure exerts on the end face 72 of the valve body 71. The force of the force storage element 59 and the pressure ratio between the pressure of the prechamber 74 and the compressed gas and also the cross-sectional ratios between the ejection opening 18 and the third pressure surface 86 are adapted in such a way that a sufficient reserve force is present for the drive apparatus 31 in order if appropriate to compensate for thermally induced pressure tolerances, so that the closure apparatus 12 can always be securely opened.

FIG. 6 shows a further embodiment of a closure apparatus 12. With regard to points of correspondence to the embodiment according to FIGS. 4 and 5, reference is made to the description concerning the embodiment according to FIGS. 4 and 5. In contrast thereto, the holding sleeve 76 is for example molded in one piece onto the cover 17. Transverse holes 85, which allow during raising of the valve body 71 from the valve seat 51 the compressed gas to flow out from the outlet opening 18 into the pressure bag 22 via the transverse hole 85, are provided in this holding sleeve 76.

A pressure channel 82, which completely penetrates the valve body 71 and the anchor 42 which is preferably molded thereon in one piece, is provided in the valve body 71. Upstream of the pressure channel 82, a restrictor 83 is embodied as a fixed restrictor which acts during an opening movement. Owing to the passage via the restrictor 83, the same pressure is applied in the prechamber 74 as in the pressure container 16.

Atmospheric pressure is applied in the pressure bag 22, meaning that atmospheric pressure is applied via the transverse holes 85 and an annular peripheral groove 87. The valve seat 51 seals the pressure volume in the pressure container 16, the size or the width of the valve seat 51 being determined by the arrangement of a groove 87 in the cover 17 and an oblique surface 88 on the valve body 71. The second valve seat 77 is embodied as a sealing surface and seals the prechamber 74 against the atmospheric pressure. This seal or sealing surface is provided as an alternative to the annular seals on the guide 78 according to FIGS. 4 and 5. In addition, a sliding seal can be provided for guiding the piston or the valve body 71 and also for sealing the prechamber 74.

In order to attain sealing pressures which are as high as possible for the closure device 12, the annular surface of the valve body 71, which rests against the valve seat 51, is kept as small as possible in relation to the end face 81 of the outlet opening 18. This can be assisted by the design measure via the groove 87 and the oblique surface 88. The difference in the size of the sealing surface on the valve seat 77 relative to the outer circumference of the valve seat surface 51 should also be kept as small as possible. Preferably, a phase or an oblique surface 88 is provided on the outer circumference of the valve seat 77 or the sealing surface and also on the outer circumference of the valve body 71, pointing in each case toward the valve seat surface, in order to reduce the size of the surface of the valve seat 77. This configuration or geometrical design of the closure apparatus 12 allows the piston 71, which seals the pressure space in the pressure container 14 against the environment via sealing seats, to float in compressed gas and thus to be free from compressive forces. The sealing force is applied exclusively or almost exclusively by the compression spring 59. Good adaptation to the seals used, which allow even long-term sealing, is thus possible. Control becomes very effective and can be carried out in an exact manner. For the outflow of the compressed gas, the compressed gas requires merely a slight deflection in order to flow into the pressure bag 22 through the radially arranged transverse holes 85.

Additionally or alternatively, the sealing surface of the valve seat 77 or an opposing installation can comprise a ring seal 79. The same applies to the end side 81 of the valve body 71 or the opposing abutment surface which forms the valve seat 51. In this case, the positioning of the seals 79, which are embodied in particular as a seat seal, are adapted in diameter in such a way that the prechamber pressure in the prechamber 74 and the pressure, acting on the valve body 71, of the force storage element 59 is greater than the internal pressure in the pressure container 14 and the atmospheric pressure which both act on the valve body 71. The closing force results therefrom.

FIGS. 7a and b show a further alternative embodiment of the force-reducing device 33 for a closure apparatus 12. This embodiment is a modification of the embodiment according to FIG. 6. With regard to the points of correspondence, reference is made to the description concerning FIG. 6. FIG. 7a shows the closure apparatus 12 in a closed position and FIG. 7b shows it in an open or outflow position. The valve body 71 comprises a valve body 95 of a second control valve 93 which is embodied as a servo control valve or as a force-reducing control valve for reducing the opening forces. The valve body 95 of the control valve 93 is provided in the valve body 71 in a longitudinally movable manner. This valve body 95 is connected to the anchor 42. Via a spring ring 97, the valve body 95 is secured relative to the valve body 71 and delimited with regard to the opening movement thereof. The internal pressure of the pressure container 16 enters the channel 82 via the restrictor valve 83 and acts on a conical surface of the valve body 95. The conical surface of the valve body 95 closes a through-hole 92 through which the medium in the pressure container 14 can enter the pressure bag 22 via the transverse channels 85 after the raising of the valve body 95.

The force storage elements 59 shown in FIG. 7a can both be provided. Alternatively, it is also possible for only one of the two force storage elements 59 to be provided. Also shown in this embodiment is a sealing sleeve 79 which separates the actuator 43 from the high-pressure space with regard to the prevailing pressures.

The closing force in this embodiment results from the fact that there acts on the cross section of the conical tip of the valve body 95 of the control valve 93, which closes the opening 92, a container internal pressure and a closing force of the force storage element 59, which is opposed by an atmospheric pressure which is determined by the cross-sectional area of the hole diameter of the opening 92. Owing to the reduction of the pressure areas acting on the diameter of the opening 92, extremely low closing forces are required. This allows an activation of the actuator 43 to cause rapid opening of the control valve 73, so that the pressure acting firstly in the prechamber 74 can flow out to the environment or into the pressure bag 22. Subsequently, the container internal pressure acts on the first pressure surface 81 of the valve body 71 and raises from the valve seat surface 51, so that the medium can flow from the container interior into the pressure bag 22 directly via the transverse channels 85. This position is shown in FIG. 7b.

FIGS. 8 and 9 show a further alternative embodiment of the force-reducing device 33 for a closure apparatus 12. In this embodiment, the holding sleeve 76 is for example integrally connected to the cover 17. The valve body 71 is provided in the prechamber 74 so as to be able to move freely. The prechamber 74 is delimited by an intermediate flange 91 which, opposite this, receives the housing 62 of the drive apparatus 31 and is fastened, in particular by a screw connection, to the holding sleeve 76, a seal 79 preferably being interposed. The intermediate flange 91 comprises an opening 92 connecting the prechamber 74 to the environment via a transverse hole 94. This opening 92 can be activated by a valve body 95 of the control valve 93.

The closing force-reducing device 33 comprises in turn the components between the valve seat 51 of the ejection opening 18 and the drive apparatus 31. The drive apparatus 31 comprises an anchor 42 which can be connected to the valve body 95 integrally or by a releasable connection, the valve body being in turn a component of the control valve 93 and a part of the closing force-reducing device 33. The force storage element 59 is in turn mounted by the drive apparatus in a chamber 61 of the housing 62 and moves the valve body 95 into a closed position relative to the opening 92.

The following activation results from this arrangement. As in the preceding embodiment, the valve body 71 is pressed downward with ambient pressure by the pressure of the prechamber 74 against the forces in the region of the first pressure surface 81 and the force of the third pressure surface 86. The pressure difference between the compressed gas and the prechamber volume is adjusted via the restrictor valve 83. In this embodiment, the control valve 93, which operates merely against ambient pressure and the spring force of the force storage element 59, is activated for opening the valve body 71. As soon as the control valve 93 opens the opening 92, the pressure prevailing in the prechamber 74 can flow out to the environment, as a result of which in the prechamber 74 the pressure decreases and becomes less than that acting on the first pressure surface 81. This causes opening of the valve body 71, so that the compressed gas can flow out of the interior of the pressure container 41, as is illustrated in FIG. 7. The compressed gas flows out of the pressure container 14 via the ejection opening 18, is deflected on the end face 72 and passes via an annular space 80, a large number of holes or hole segments into one or more transverse channels 85 which guide the compressed gas into the interior of a pressure bag 22.

The force storage element 59 is designed in such a way as to provide a sufficient force which, in the currentless state of the drive apparatus 31, closes the control valve 93 and which is preferably greater than the force resulting from the pressure of the prechamber 74 and the cross section, lying in the first pressure surface 82, of the channel 82. During closing of the control valve 93, the restrictor valve 83 is opened owing to the excess pressure, which is still present, of the compressed gas, so that the pressure, which can be preset by the restrictor valve 83, in the prechamber 74 is re-established. As a result, the valve body 71 is moved downward and closes the ejection opening 18. In this case, the end side 72 of the valve body 71 rests against the first valve seat 51. At the same time, the end face 72 abuts against the second valve seat 77 which is provided on the holding sleeve 76. This causes, in turn, the ambient pressure to act on the third pressure surface 86 and also the container internal pressure to act on the first pressure surface 81. The compressed gas can thus be emitted into the pressure bag 22 in a metered manner by way of rapid, successive opening and closing processes of the control valve 93. This arrangement allows a gentle activation with a short activation time to be attained.

FIG. 10 shows a further embodiment of a closure apparatus 12 as an alternative to FIGS. 8 and 9 in a closed position. FIG. 11 shows the alternative embodiment according to FIG. 10 in a working position.

The closure apparatus 12 has been modified compared to those in FIGS. 8 and 9 in that a forced activation is provided for the opening movement of the valve body 71. For this purpose, the valve body 71 is preferably embodied in two parts. The valve body 71 comprises a lower or first region which has an end face 72 and receives, opposite this, the opening 92. This opening 92 is displaced by the intermediate flange 91 into the valve body 71. The intermediate flange 91 receives the valve body 71 in a displaceable manner. As a result, the entire control valve 93 is movable relative to the intermediate flange 91. The opening 92 merges via a connecting hole 98 with a transverse hole 94 provided in the intermediate flange 91. The guide portion 96 is fastened by a screw connection to the lower part of the valve body 71 in order to allow simple mounting. The valve body 95 of the control valve 93 is guided substantially in the lower part of the piston in order to open the opening 92 which is connected to the prechamber 74 by channels 99. The valve body 95 has additional guide portions 101 by which the valve body can be guided in a wall portion in the guide portion 96. Furthermore, a spring ring 97 or the like, which forms an undercut for the further guide portion 101 on the valve body 95, is inserted in the guide portion 96. The valve body 95 is in turn connected to the anchor 42 of the drive apparatus 31, a force storage element 59 being provided in the chamber 61 of the housing 62 of the drive apparatus 31 and transferring the valve body 95 of the control valve 93 into a closed position.

This device 33, which reduces the closing force, functions firstly like that according to the embodiment in FIGS. 7 and 8. On activation of the control valve 93 for opening the opening 92, a free movement of the valve body 95 of the control valve 93 first takes place. Subsequently, the entire valve body 71 is forcibly raised via the additional guide portion 101 which rests against or reaches behind the spring ring 97. As soon as the drive apparatus 31 is switched to the currentless state or is switched off, the force storage element 59 presses in turn the valve body 95 downward against the opening 92. As the prechamber volume is substantially pressureless, the restrictor valve 83 opens, and the set pressure difference between the gas pressure in the pressure container 14 and the prechamber pressure is re-established. The closing movement of the valve body 71 is initiated and if appropriate assisted by the force storage element 59 which presses the valve body 71 against the first and second valve seat 51, 77.

The closure apparatuses 12 according to FIGS. 8 to 11 thus have a pneumatic servo mechanism. The closure apparatus 12 according to FIGS. 1 to 3 has, on the other hand, a mechanical servo mechanism. The device 33 thus reduces the actuating force for opening and/or closing of the ejection opening by at least one valve body.

All features described hereinbefore are each per se essential to the invention and can be combined with one another in any desired manner.

1. A closure apparatus for a pressure container, which can be filled with compressed gas, of a cold gas generator, the pressure container comprising at one end a closed base and at the other end a container opening on which the closure apparatus can be arranged for forming a cold gas generator, having a valve body which, in a rest position, closes an ejection opening communicating with the environment and which can be transferred into a working position by way of a drive apparatus for opening the ejection opening, characterized in that a device which reduces the closing force to be applied and activates the at least one valve body between a rest position and a working position is provided between at least one valve seat of the ejection opening and the drive apparatus.

2. The closure apparatus as claimed in claim 1, characterized in that the device has a pressure element having at an end pointing toward the valve body at least one pressure surface, in particular a conical pressure surface, by which at least one valve body can be transferred for abutment in a valve seat.

3. The closure apparatus as claimed in claim 1, characterized in that there are provided on a valve insert arranged in the ejection opening a large number of radially oriented openings which each have a valve seat and with each of which a valve body is associated and the pressure surface of the pressure element acts on the valve bodies.

4. The closure apparatus as claimed in claim 1, characterized in that the pressure element can be activated by the drive apparatus so as to be displaceable to at least one valve body and the pressure surface on the pressure element is oriented at an acute angle to the direction of displacement.

5. The closure apparatus as claimed in claim 1, characterized in that a radially running abutment surface, which delimits a receiving space between the valve insert and the pressure surface of the pressure element, is provided adjacent to the radially oriented opening of the valve insert.

6. The closure apparatus as claimed in claim 1, characterized in that the pressure element has a cup-shaped portion which surrounds the valve bodies and has at the internal free end the pressure surface and comprises through-openings, preferably between a base and the pressure surface.

7. The closure apparatus as claimed in claim 1, characterized in that the pressure element has, at an end portion of the valve insert that protrudes in the cup-shaped portion, a guide acting on an outer circumference of the valve insert.

8. The closure apparatus as claimed in claim 1, characterized in that a force storage element, in particular a compression spring which applies a force to the pressure element in the closing direction, is provided between the drive apparatus and the pressure element.

9. The closure apparatus as claimed in claim 1, characterized in that the force storage element 9 is provided in a chamber of the drive apparatus, which has lateral openings leading to a pressure bag.

10. The closure apparatus as claimed in claim 1, characterized in that the valve insert can be fastened, preferably releasably, into an ejection opening in the cover of the pressure container.

11. The closure apparatus as claimed in claim 1, characterized in that the drive apparatus 3 has a fastening portion which acts on a connecting edge of a cover and closes the container opening of the pressure container.

12. The closure apparatus as claimed in claim 10, characterized in that the cover has a central ejection opening.

13. The closure apparatus as claimed in claim 10, characterized in that the cover comprises an excess pressure limiting valve which is provided in a hole and connects the ejection opening to the environment.

14. The closure apparatus as claimed in claim 1, characterized in that a further fastening portion for a pressure bag, which can be filled with compressed gas, is provided on the connecting edge.

15. The closure apparatus as claimed in claim 1, characterized in that the device has a valve body which is embodied as a piston, abuts with an end face against a valve seat on the ejection opening and has a first pressure surface and in that the valve body is arranged opposite in a prechamber in which a restrictor valve can be used to set a prechamber pressure which is reduced compared to the operating pressure of the compressed gas and acts on a second pressure surface of the piston.

16. The closure apparatus as claimed in claim 15, characterized in that the restrictor valve is provided in a channel connecting the prechamber to the pressure container.

17. The closure apparatus as claimed in claim 15, characterized in that the valve body is held by a holding sleeve which can be arranged on the drive apparatus and is arranged in one piece on the cover or via screw connections to the connecting portion, and the holding sleeve comprises a guide for the valve body.

18. The closure apparatus as claimed in claim 15, characterized in that the valve body has, between the valve seat and a further valve seat formed by the holding sleeve, a third pressure surface to which atmospheric pressure is applied.

19. The closure apparatus as claimed in claim 15, characterized in that sealing elements are provided between the holding sleeve and the housing of the drive apparatus and preferably between the guide of the holding sleeve and the valve body.

20. The closure apparatus as claimed in claim 15, characterized in that a force storage element, in particular a compression spring which exerts a force in the closing direction, is provided in the prechamber.

21. The closure apparatus as claimed in claim 15 characterized in that a stroke movement in the opening direction of the valve body can be activated directly by the drive apparatus.

22. The closure apparatus as claimed in claim 15, characterized in that the opening movement of the valve body in the prechamber can be controlled by a prechamber pressure and preferably a control valve opens a through-opening between the prechamber and the environment.

23. The closure apparatus as claimed in claim 22, characterized in that the control valve can be activated by the drive apparatus 3.

24. The closure apparatus as claimed in claim 22, characterized in that the control valve can be arranged into a closing position by way of a force storage element.

25. The closure apparatus as claimed in claim 22, characterized in that the control valve closes an opening in an intermediate flange which receives a drive apparatus and can be arranged on a cover.

26. The closure apparatus as claimed in claim 22, characterized in that between a guide portion of a preferably two-part valve body and a valve body of the control valve, which is at least partly surrounded by the guide portion, a forced activation of the valve body is provided in such a way that during an opening movement of the valve body on the control valve, a raising of the valve body from at least one valve seat is provided.

27. The closure apparatus as claimed in claim 26, characterized in that the forced control is carried out by an element inserted in a guide portion of the valve body, in particular a spring ring provided by a further guide portion on the valve body of the control valve.

28. The closure apparatus as claimed in claim 1, characterized in that the drive apparatus is embodied as an electromagnetic drive, as a piezoceramic plate stack drive or bending plate drive.

29. The closure apparatus as claimed in claim 1, characterized in that the activation of the drive apparatus and/or the container pressure is monitored at least by a pressure sensor of the pressure container.
